(19) United States
(12) Patent Application Publication
(10) Pub. No.: US 2013/0269167 A1
(43) Pub. Date: Oct. 17, 2013

(54) METHOD FOR THE CHIP-FREE CONNECTION OF THE PINION OR INPUT SHAFT TO THE TORSION BAR OF A SERVO STEERING SYSTEM

(71) Applicant: Hubert Heck, Dusseldorf (DE)

(72) Inventor: Hubert Heck, Dusseldorf (DE)

(73) Assignee: Thyssenkrupp Presta AG, Eschen (LI)

(21) Appl. No.: 13/994,256

(22) PCT Filed: Dec. 7, 2011
(86) PCT No.: PCT/EP2011/006145

§ 371 Date: Jun. 14, 2013

(30) Foreign Application Priority Data
Dec. 21, 2010 (DE) 10 2010 055 298.4

(51) Int. Cl. B62D 5/06

(52) U.S. Cl. CPC B62D 5/06
USPC 29/505

(57) ABSTRACT

An assembly for a motor vehicle servo steering system, having an input shaft and a pinion shaft with a torsion bar rotary slide valve, may be produced by creating a bore in the input shaft and/or pinion shaft that is undersized with respect to the size of the torsion bar to be inserted. The input shaft and/or pinion shaft may be heated and/or the torsion bar may be cooled to permit insertion of the torsion bar.

The present invention concerns a method with the features of the pre-characterising part of claim 1.

Rotary slide valves for power steering systems in motor vehicles normally comprise, inter alia, a control bushing, in which the rotary slide is rotatably arranged with its control grooves. The rotary slide for its part employs a torsion bar, which at the steering column end side of the rotary slide is connected to this, secured against rotation, and at the opposite end is rotatably supported in a needle bearing. The entire arrangement rotates approximately symmetrically about the common axis of rotation. The torsion bar allows a certain rotation between the steering column, to be more precise, the steering spindle and the drive pinion of the steering gear. Since the rotary slide is only secured against rotation at the inlet side end of the torsion bar, this twisting effects a change in position of the control grooves of the rotary slide in relation to the control bushing and thus a hydraulic control signal, which ultimately leads to operation of the power assistance.

In electromechanical power steering systems a similar design with a torsion bar as the connection between input shaft and pinion shaft is provided, wherein the torsion during operation is not just used nor hydraulic control but also as a mechanical input value for a torque sensor.

The securing of the torsion bar in the input shaft normally takes place in a shaft section of the torsion bar. In the vicinity of this area a radial bore is treated which passes through the centre of the input shaft and the torsion bar and the two components are pinned together via this through-hole. The creation of this through-hole through the two components is not without its practical problems, because the material to be used is quits hard. In addition, chips that are created during the drilling process and the resultant heat must be removed. Finally, the connection achieved is not tight. So an additional seal, for example in the form of an O-ring must be provided.

In particular when electromechanical power steering systems are used, the connection area must, as far as possible, also be free of grease, which is difficult to achieve after manufacture by machining.

A further connection method for rotary slide valves of power-steering systems provides that the shaft section of the torsion bar is provided with a coaxial blind hole, into which then in the securing position a bail is pressed or driven. The ball has s slightly larger diameter than the inner diameter of the blind hole, so that the shaft section of the torsion bar is expanded and thus secured in the bore of the rotary slide. This securing method leads to considerable axial forces on the torsion bar, the spring section of which can be adversely affected by this. The result is disadvantages in the accuracy with which, for example, the force-free hydraulic central position of the valve can be adjusted.

From published application DE 4441165 A1 a servo valve is known, in which in the connection area, of the rotary slide with the torsion bar the rotary slide has an inner contour with spiral surfaces and the torsion bar a corresponding outer contour. The non-positive connection is created by rotation of the parts against one another. This connection cannot be created in any desired relative position between the components.

From DE 19752463 A1 a connection method is known, by which an expander element expands the torsion bar from the inside out and thereby secures it in the rotary slide. Additional costs are incurred here due to the additional securing element.

Finally, from DE 10010837 A1 it is known to create the bore of the rotary slide with a non-round cross section, which under the effect of an externally acting clamping force can be deformed into a substantially round cross section. Under the effect of an externally acting clamping force the cross sections of the bore and the torsion bar are geometrically similar to the extent that the torsion bar can be freely introduced into the bore. Once the clamping force is removed the torsion bar is clamped with a friction fit in the bore that reverts back in shape. Creating the non-round bore is very involved in practice.

The object of the present invention is therefore to provide a method for the connection of an input shaft or a torsion shaft to a torsion bar, which can be carried out simply and cost-effectively without machining.

This object is achieved by a manufacturing method with the features of claim 1.

Because during the production of the input shaft and/or the pinion shaft the following steps are provided for;
producing the input shaft input shaft and/or the pinion, shaft with a bore provided for connecting to the torsion bar,
wherein the bore is produced with an undersize in relation to the outer diameter of the torsion bar,
wherein the undersize is selected such chat the torsion bar can be inserted into the bore if the input shaft and/or the pinion shaft are/is heated or if the torsion bar is cooled, and the torsion bar is seated with an interference fit in the bore after temperature equalisation between the input shaft and/or the pinion shaft and the torsion bar,
generating a temperature difference wherein the torsion bar is colder than the input shaft and/or the pinion shaft,
joining the input shaft and/or the pinion shaft and the torsion bar, and
effecting a temperature equalisation between the input shaft and/or the pinion shaft and the torsion bar by active cooling or heating or by waiting,
   and because in particular the bore provided for connecting to the torsion bar is produced with an undersize in relation to the outer diameter of the torsion bar, wherein the undersize is selected such that the torsion bar can be inserted into the bore if the input shaft and/or the pinion shaft are/is heated and after the input shaft and/or the pinion shaft is cooled the torsion bar is seated with an interference fit in the bore, joining of the input shaft and/or the pinion shaft and the torsion bars can take place without machining.

The bore of the input shaft and/or the pinion shaft can be a simple circular bore. Similarly the end area of the torsion bar provided for securing to the input shaft and/or the pinion shaft can have a cylindrical, circular cross section. The orientation of the torsion bar in relation to the input shaft is not set. Thus the assembly can still be adjusted prior to cooling of the input shaft, which is advantageous for setting the central position of this assembly. Finally, the connection achieved following cooling of the input shaft is gas-tight without the need for additional sealing measures.

The connection between the input shaft and/or the pinion shaft and the torsion bar can be designed with a smaller diameter than in the prior art, since no machining is necessary during assembly. As a result a simpler bar can be used as the torsion bar, without the diameter being enlarged in the end areas. The corresponding component is thus smaller, lighter and cheaper. The spring rate can be set by selecting the length of the torsion bar, so that the same material can be used for a plurality of different torsion bars.

The connection between the torsion bar and the pinion shaft can also be created in a corresponding manner.

The temperature differential between the input shaft or the pinion shaft and the torsion bar should be approximately 200 to 300° C. during production, wherein it is possible for example to heat the input shaft or the pinion shaft inductively. It is similarly possible for example, to cool the torsion bar by using liquid nitrogen.

In a preferred embodiment the bore for securing the torsion bar in the input shaft takes the form of a blind hole, so that a gas seal can be ensured with absolute certainty in this area.

The method described in this respect is particularly advantageous, if prior to connection provision is made to adjust the arrangement, depending on the design of the power steering system, to a hydraulic or electrical central position.

In the following, an exemplary embodiment of the present invention is described using the drawing. This shows as follows:

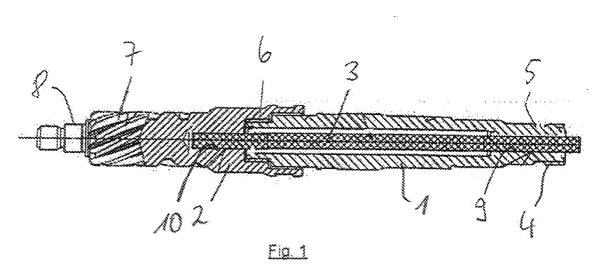

FIG. 1: an input shaft with a torsion bar and a pinion shaft nor a vehicle power steering system in cross-section from the side.

FIG. 1 shows a second assembly with an input shaft 1, a pinion shaft 2 and a torsion bar 3 in a longitudinal section. The assembly can be provided for a hydraulic power steering system or an electromechanical power steering system. The input shaft 1 has a connection 4 for a steering shaft. The connection 4 has a multi-tooth design at an end area 5 of the input shaft 1. A bearing 6 rotatably supports the input shaft 1 in the pinion shaft 2. The input shaft 1 is introduced into the pinion shaft 2 in the area of the bearing 6. The pinion shaft 2 also has a tooth system 7, by which during operation of the motor vehicle a steering rack (not shown) of a steering gear is driven. The pinion shaft 2 is also provided with a bearing seat 8 at its free end, with which the pinion shaft 2 is supported in a gearbox housing.

The input shaft 1 and the pinion shaft 2 are designed to be substantially rotationally symmetrical and are arranged coaxially to one another.

In its end area 5 the input shaft 1 has a concentric, axially parallel through-hole 9. The torsion bar 3 is inserted in the through-hole 9. In similar manner, the pinion shaft 2 has a blind hole 10, into which the torsion bar 3 is inserted with its second end. In this exemplary embodiment, the torsion bar 3 is a torsion bar with a cross section that, is constant over its length. In other exemplary embodiments (not shown) a conventional torsion bar can be used, in which the end areas for securing in the input shaft and the pinion shaft are designed to be thicker than the central torsion area.

The through-hole 9 of the input shaft 1 and in this example also the blind hole 10 of the pinion shaft 2 are designed with an undersize in relation to the outer diameter of the torsion bar 3. The undersize is selected such that the torsion bar 3 can be inserted into the bore 3 and into the blind hole 10, if there is a temperature differential of approximately 200 to 300° C. between the torsion bar 3 and the input shaft 1 and the pinion shaft 2. After cooling of the input shaft 1 and the pinion shaft 2 the diameter of the bores 9 and 10 is reduced to the extent that the torsion bar 3 sits securely with an interference fit in the bores 9 and 10.

During production initially the individual components are manufactured, deburred and cleaned. Prior to completion of the assembly cleaning of the input shaft 1 and the pinion shaft 2 can still be performed such that a virtually completely grease-free condition can be achieved. Then with this exemplary embodiment the pinion shaft 2 is heated inductively to approximately 300° C. and the torsion bar 3, which has not been heated, is inserted into the bore 10. The pinion shaft 2 can then cool, as a result of which the inner diameter of the bore 10 reduces and the torsion bar 3 is seated therein with an interference fit. Then the bearing 6 is placed on the input shaft 1. The area of the bore 9 of the input shaft 1 is for its part inductively heated to approximately 300° C. and then the input shaft 1 passed over the torsion bar 3, until the bearing 6 is positioned at the seating provided in the input shaft 2, The torsion bar 3 is then in the through-hole 9 of the input shaft 1 at the intended position. During subsequent cooling of the input shaft l the diameter of the bore 9 also reduces such that the torsion bar 3 is seated with an interference fit in the bore 9. Thus the assembly is complete.

Prior to cooling of the input shaft I the relative angle of rotation of the input shaft 1 relative to the pinion shaft 2 can still be adjusted. To hydraulic rotary slide valves, which can contain the assembly according to FIG. 1, this adjustment is known as hydraulic balancing. In electrical power steering systems the assembly is designed as part of a torque sensor and here the zero position of the torque sensor can be set provided that the input shaft 1 is still heated.

As has been explained above, the bore 9 can be designed as a blind hole. The joining of the torsion bar 3 in the bores 9 and 10 can also take place by cooling the torsion bar, for example to the temperature of the liquid nitrogen. It can also be provided that the torsion bar 3 is secured in the pinion shaft 2 in a conventional manner.

Overall, a production method results in which the torsion bar can be inserted without machining into the input shaft. Additional connection elements are unnecessary. Furthermore the internal area is necessarily sealed from the external area.

1. A method of producing an assembly for a motor vehicle power steering system including an input shaft and pinion shaft with a torsion bar, the method including:
producing the input shaft and/or the pinion shaft with a bore provided for connecting to the torsion bar,
wherein a size of the bore is less than an outer diameter of the torsion bar,
wherein the degree to which the size of the bore is less than the outer diameter of the torsion bar is selected such that the torsion bar can be inserted into the bore if the input shaft and/or the pinion shaft are/is heated or if the torsion bar is cooled, and such that the torsion bar will be seated with an interference fit in the bore after temperature equalisation between the input shaft and/or the pinion shaft and the torsion bar,
generating a temperature difference, wherein the torsion bar is colder than the input shaft and/or the pinion shaft,
joining the input shaft and/or the pinion shaft and the torsion bar, and
effecting a temperature equalisation between the input shaft and/or the pinion shaft and the torsion bar.

2. The method according to claim 1, wherein the bore of the input shaft and/or the bore of the pinion shaft is a circular bore.

3. The method according to claim 1, wherein an end area of the torsion bar has a cylindrical, circular cross section.

4. The method according to claim 1, further comprising adjusting the assembly prior to temperature equalisation.

5. The method according to claim 1, wherein the torsion bar is a bar with a diameter that is constant over its length.

6. The method according to claim 1, wherein a temperature differential during joining of the input shaft or the pinion shaft and the torsion bar during production is approximately 200 to 300° C.

7. The method according to claim 1, wherein the generating a temperature difference includes inductively heating the input shaft or the pinion shaft.

8. The method according to claim 1, wherein the generating a temperature difference includes cooling the torsion bar by the use of liquid nitrogen.

9. The method according to claim 1, wherein the bore for securing the torsion bar is created in the input shaft as a blind hole.
